(19) United States
(12) Patent Application Publication
(10) Pub. No.: US 2007/0247856 A1
(43) Pub. Date: Oct. 25, 2007

(54) Lighting unit reflector

(76) Inventors: Shih Chang Wang, Chung-Ho City (TW); Bok Lian Lau, Melaka (MY); Feng Wu, Chong-Li City (TW); Chin-Wang Tu, Cupertino, CA (US); Chen-Ho Wu, Los Altos Hills, CA (US)

Correspondence Address: DLA PIPER US LLP, 2000 UNIVERSITY AVENUE, E. PALO ALTO, CA, 94303-2248, US

(21) Appl. No.: 11/732,965

(22) Filed: Apr. 4, 2007

Related U.S. Application Data
(60) Provisional application No. 60/789,726, filed on Apr. 5, 2006.

(51) Int. Cl. F21V 7/00

(52) U.S. Cl. 362/297; 362/346; 362/347

(57) ABSTRACT

A lighting unit that includes a light source and a reflector assembly upon which the light source is mounted. The reflector assembly includes a first reflector having a first curved reflective surface extending away from the light source, and a second reflector having a second curved reflective surface extending away from the light source. The first curved reflective surface faces and opposes the second curved reflective surface. The first curved reflective surface has a curvature that is different from that of the second curved reflective surface. The first and second curved reflective surfaces both preferably terminate in convexities that reduce the size of dark band areas of illumination.

This application claims the benefit of U.S. Provisional Application No. 60/789,726, filed Apr. 5, 2005, and entitled Improved LED Luminaire Reflector Design.

### FIELD OF THE INVENTION

The present invention relates to a reflector design especially ideal for Light-Emitting Diode (LED) lighting unit (luminaire) applications. More particularly, the present invention relates to a method and apparatus for efficiently redirecting light from LED applications so as to provide desirable angular distributions.

### BACKGROUND OF THE INVENTION

Light-Emitting Diodes (LEDs) have been used in many applications to replace conventional incandescent lamps, fluorescent lamps, neon tube and fiber optics light sources in order to reduce costs and to increase reliability. Due to the fact that LEDs consume less electrical energy than most conventional light sources, while exhibiting a much longer lifetime, many designs have been invented for various applications, such as traffic signal lights, channel letter modules, conventional illuminated commercial signs, street name signs, and street lights.

LEDs typically have a hemispherical top and are centered on an optical axis through the center of the LED. An LED lamp typically radiates symmetrically in a Lambertian or Batwing pattern 360 degrees around the center of the optical axis. The angular intensity distribution of a Lambertian pattern peaks at the optical axis and decreases according to the cosine law of the angle from the axis. A Batwing pattern peaks off the optical axis, with a lower intensity at the optical axis. For street light applications, a lighting unit comprising an LED lamp is often installed 25 feet or higher from the street surface, such that LED light rays are redirected towards a desired location by way of a reflector apparatus. Such designs, however, often yield narrow light patterns that are focused on a limited area just below the lighting unit, if the shape of the reflector is not appropriately designed, which is not desirable for many street light applications.

Many different types of reflectors have been used, including cone-shaped reflectors. In FIG. 1, a schematic diagram of a cone-shaped reflector 20 coupled to a light source 10 is shown. As illustrated, light source 10 emits a plurality of light rays including light rays 30, 32, 34, 40, 42, and 44. Of these light rays, only light rays 30 and 40 are reflected by reflector 20. Namely, light rays 30 and 40 each reflect off of reflector 20 and are then incident upon locations 54 and 64, respectively. The remaining light rays 32, 34, 42, and 44, however, are not reflected, and are thus directly incident upon locations 52, 54, 62, and 64, respectively.

Cone-shaped reflector designs inherently cause some areas to have greater light intensities than others, which results in undesirable darker bands in the illuminated area. The areas of greater intensity, for example, result from some locations being illuminated simultaneously by both directly emitted light rays and reflected light rays, such as locations between 54 and 64. Meanwhile, the areas of lesser intensity result from locations being illuminated by directly emitted light rays as well as rays reflected from the far side of the reflector, but not from reflections from the near side of the reflector, such as locations 52 and 62. It should be noted that the cross-sectional area depicted by line segment 70 in FIG. 1 represents the plurality of locations whereby higher intensity light from directly emitted light rays and reflected light rays are incident, while the cross-sectional areas depicted by line segments 50 and 60 represent the plurality of locations where directly emitted light rays but less reflected light rays are incident. The light intensity of the darker bands 50 and 60 is further compromised because these areas are offset from the peak of the Lambertian or Batwing pattern. Thus, even the directly emitted light rays in these areas have less intensity than the directly emitted light rays closer to the center of the light distribution pattern of the light source (i.e. area 70).

In addition to the cone-shaped reflectors previously discussed, reflector tray designs have also been used for street light applications. In FIG. 2A, a schematic diagram of a flat-surface multi-LED reflector tray is provided as an example of such a design. As illustrated, reflector tray 100 comprises LED array 110, bottom reflector 120, top reflector 122, right reflector 124, and left reflector 126. In FIG. 2B, a cross-sectional view of a reflector tray is provided to help illustrate the distribution created by such design. As shown, light source 110 emits a plurality of light rays including light rays 130, 132, 134, 140, 142, and 144. Of these light rays, only light rays 130 and 140 are reflected. Namely, light rays 130 and 140 each reflect off of reflectors 120 and 122, respectively, and are then incident upon locations 154 and 164, respectively. The remaining light rays 132, 134, 142, and 144, however, are not reflected, and are thus directly incident upon locations 152, 154, 162, and 164, respectively

For street light applications, reflector tray designs provide more flexibility with respect to angular distribution than cone-shaped reflectors. Because most street light applications require light to be directed down towards the street, such flexibility is often desirable. In FIG. 2B, for example, bottom reflector 120 and top reflector 122 are positioned according to their respective angles of inclination 121 and 123, so that light from source 110 is generally directed downwards and forward in the direction toward the other side of the street.

Nevertheless, similar to cone-shaped reflectors, reflector tray designs can provide for undesirable dark bands created by some portions of the illuminated area having greater light intensities than others. In FIG. 2B, for example, because locations between 154 and 164 are illuminated simultaneously by both directly emitted light rays and reflected light rays, these locations have a greater light intensity than locations 152 and 162, which are illuminated by directly emitted light rays and light rays reflected by the far side of the reflector. And, areas 152 and 162 are illumined by directly emitted light rays having a lesser intensity given their location within the Lambertian or Batwing distribution pattern. Here, however, it should be noted that light rays 130 and 140 are respectively incident upon reflectors 120 and 122 at angles 131 and 141, respectively. Light rays 130 and 140 are then respectively reflected by reflectors 120 and 122 at angles of 133 and 143, respectively (wherein, angle 131=angle 133, and angle 141=angle 143). The angles at which light rays reflect off of a particular reflector thus dictates where, if at all, such reflected rays will be coupled with a directly emitted ray so as to create an illuminated area having a greater light intensity. In FIG. 2B, the cross-sectional area depicted by line segment 170 represents the plurality of locations whereby the higher intensity portion of the directly emitted light rays and reflected light rays are incident, while the cross-sectional areas depicted by line segments 150 and 160 represent the plurality of locations where mainly the lower intensity of the directly emitted light rays are incident as well as some reflected light rays from just the far side of the reflector.

In light of these limitations, there is currently a need for a more efficient reflector design. It is therefore desirable to develop a method and apparatus for redirecting light from LED lighting unit applications so as to provide wider and more efficient angular distributions. Moreover, it is desirable to provide an improved reflector surface design that can efficiently spread light over a wider area and minimize dark bands. Such a reflector design would represent a major improvement in lighting unit output light pattern management.

### SUMMARY OF THE INVENTION

The present invention solves the aforementioned problems by providing multiple and varying curved-surface reflectors, which substantially reduce dark band areas and distribute light to a wider area than conventional designs.

A lighting unit includes a light source and a reflector assembly upon which the light source is mounted. The reflector assembly includes a first reflector having a first curved reflective surface, and a second reflector having a second curved reflective surface, wherein the first curved reflective surface has a curvature that is different from that of the second curved reflective surface.

In another aspect, a lighting unit includes a light source and a reflector assembly upon which the light source is mounted. The reflector assembly includes a first reflector having a first curved reflective surface extending away from the light source, and a second reflector having a second curved reflective surface extending away from the light source. The first curved reflective surface faces and opposes the second curved reflective surface. The first curved reflective surface has a curvature that is different from that of the second curved reflective surface.

Other objects and features of the present invention will become apparent by a review of the specification, claims and appended figures.

### BRIEF DESCRIPTION OF THE DRAWINGS

FIG. 1 is a schematic diagram of a conventional cone-shaped reflector.

FIG. 2A is a schematic diagram of a conventional flat-surface multi-LED reflector tray.

FIG. 2B is a schematic cross section view of a conventional flat-surface multi-LED reflector tray.

FIG. 3 is a schematic cross section view of a curved-surface multi-LED reflector tray according to an embodiment of the present invention.

FIG. 4A is a plot of contour lines illustrating the varying lighting unit intensities of a flat-surface reflector tray over a particular area.

FIG. 4B is a plot of contour lines illustrating the varying lighting unit intensities of a curved-surface reflector tray over a particular area.

FIG. 5 is a schematic cross section view of an apparatus with multiple rows of curved-surface multi-LED reflector trays according to an embodiment of the present invention.

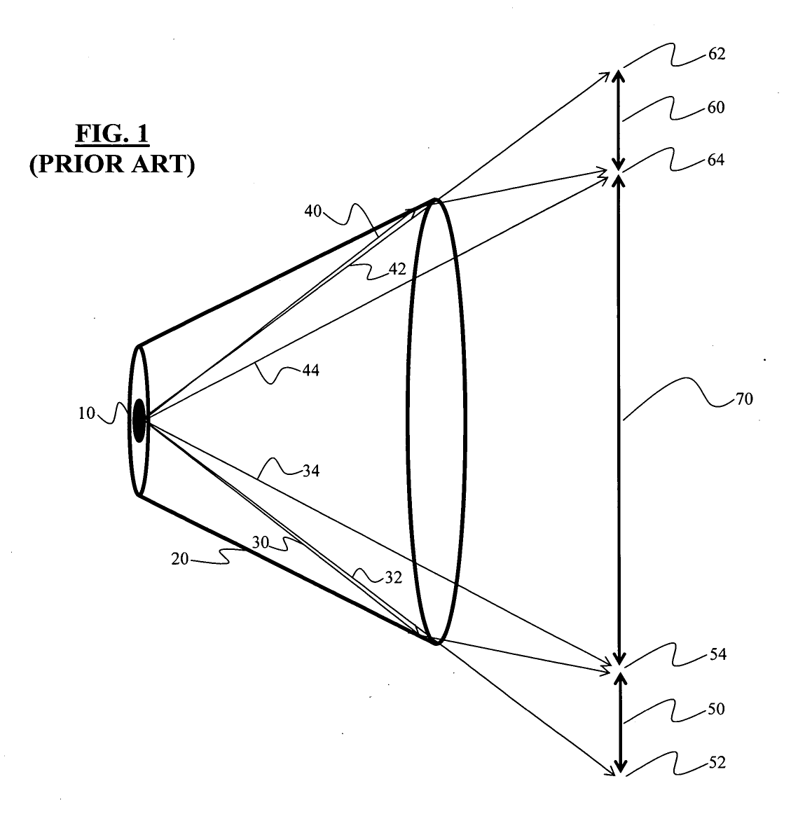

### DETAILED DESCRIPTION OF THE PREFERRED EMBODIMENTS

The present invention is an improved reflector design for LED lighting unit applications. More particularly, the present invention is a method and apparatus for efficiently redirecting light from LED lighting unit applications so as to reduce dark bands and increase the scope of a lighting unit's 50% peak intensity contour line.

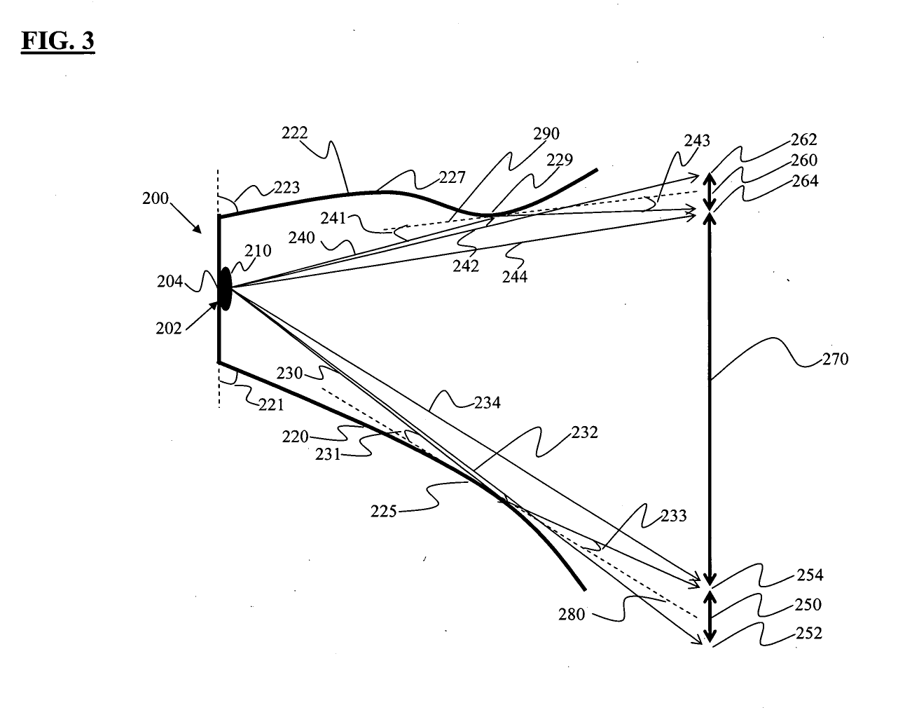

The present invention provides a curved-surface reflector design, which substantially reduces dark band areas and distributes light to a wider area than conventional designs. FIG. 3 illustrates a cross-sectional view of a lighting unit 200 having a curved-surface multi-LED reflector tray design. As illustrated, lighting unit 200 comprises a light source 210 mounted onto a reflector assembly 202. Reflector assembly 202 includes a back plate 204, and lower and upper curved reflectors 220, 222 extending therefrom (although back plate 204 can be omitted or formed integrally as part of the curved reflectors 220, 222). In a preferred embodiment, lower curved reflector 220 is positioned at an angle of inclination 221, which is smaller than the angle of inclination 223 of upper curved reflector 222 (wherein angle of inclination 223 is approximately ninety degrees). The inner surfaces of reflectors 220, 222 (i.e. those facing each other) are reflective. Optional back plate 204 may or may not have a reflective surface.

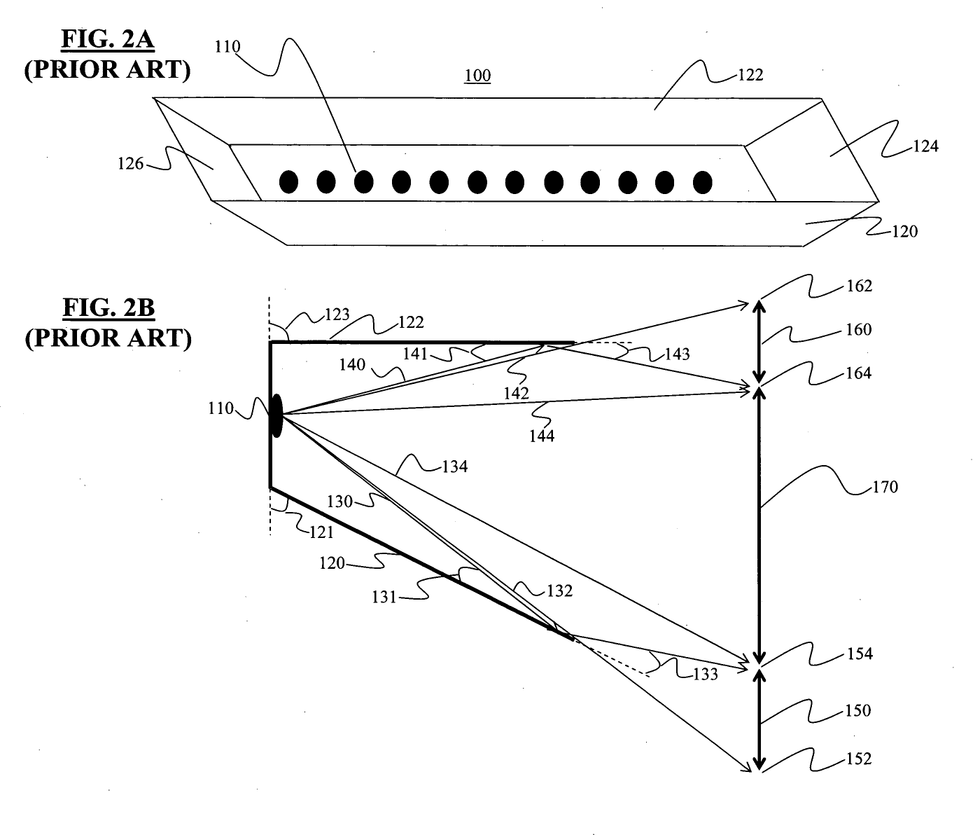

The reflective inner surface of upper curved reflector 222 further comprises a concavity 227 proximate to light source 210 and positioned so as to reflect more light toward location 250. The reflective surface of upper curved reflector 222 terminates in a convexity 229, which is rounded outwardly away from reflector 220, so as to reflect light relative to a line 290 tangent to the curvature of convexity 229. In FIG. 3, for example, light ray 240 is incident upon convexity 229 at an angle 241 relative to tangent line 290. Light ray 240 is then reflected at an angle 243 relative to tangent line 290 and becomes incident upon location 264. Here, it should be noted that, upon comparing FIG. 2B with FIG. 3, the curvature of convexity 229 causes light ray 240 to be reflected at an angle 243 which is smaller than reflection angle 143 of flat-surface reflector 122. As a result of this smaller reflection angle 243, light rays 240 and 244 are both incident upon location 264 which, together with location 262 whereupon only light ray 242 is incident, create a dark band area 260 that is smaller than the analogous dark band area 160 created by flat-surface reflector 122 in FIG. 2B.

The reflective surface of lower curved reflector 220 also preferably terminates in a convexity 225, which similarly minimizes dark band area 250 relative to dark band area 150 in FIG. 2B. As illustrated, convexity 225 is rounded outwards and reflects light relative to a line 280 tangent to the curvature of convexity 225. For example, light ray 230 is incident upon convexity 225 at an angle 231 relative to tangent line 280. Light ray 230 is then reflected at an angle 233 relative to tangent line 280 and becomes incident upon location 254, along with light ray 234. Here again, because reflection angle 233 is smaller than reflection angle 133 in FIG. 2B, the dark band area 250 between location 254 and location 252 (whereupon only light ray 232 is incident) is smaller than the analogous dark band area 150 of flat surface reflector 120. Accordingly, as a consequence of dark band areas 250 and 260 being reduced, an increase in the area of greater light intensity 270 is achieved. At the same time, the contrast between the intensity in locations 270 and 250 is relatively smaller than that between locations 170 and 150 of FIG. 2B. Consequently, darker bands are not as visible as well.

In street light applications, how far the 50% peak intensity contour line can reach on the pavement surface in terms of the mounting height (MH) define the “Type” of street light. For instance, a Type II lighting unit is one in which the 50% contour line reaches the region between 1.0 MH and 1.75 MH, while a Type III lighting unit is one in which the 50% contour line reaches between 1.75 MH and 2.75 MH, according to the Parking Lot and Area Luminaires section of the July 2004 NLPIP (National Lighting Product Information Program) Specifier Reports (Vol. 9 No. 1).

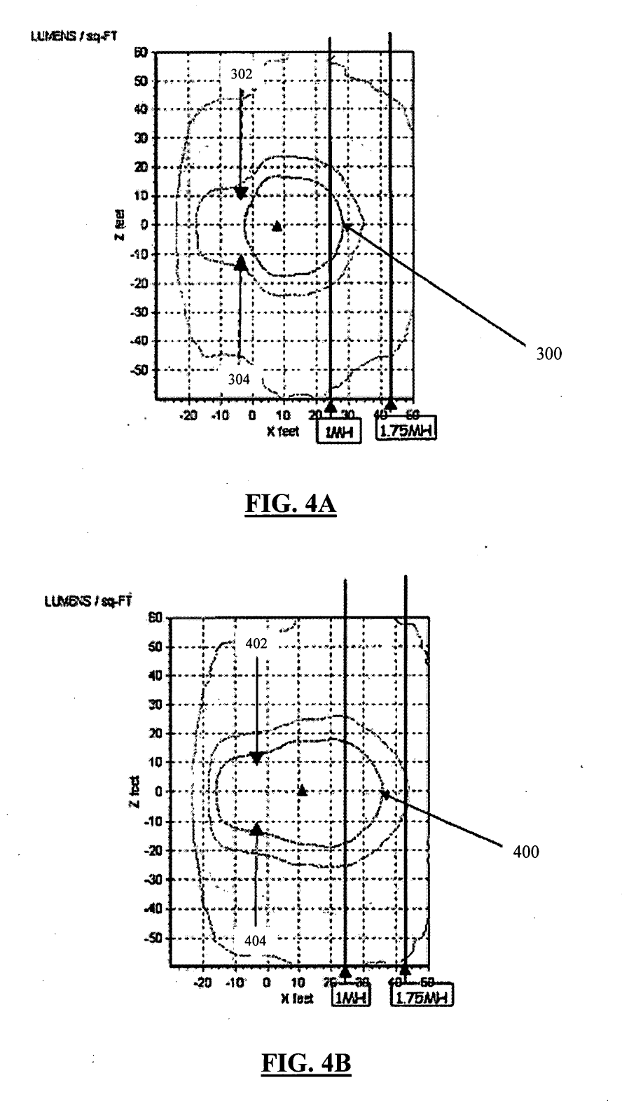

The improved performance of the curved-surface reflector design of the present invention, relative to conventional flat-surface reflector designs, is quantified in the ASAP optical simulations provided in FIGS. 4A and 4B. In FIG. 4A, a plot of contour lines illustrating the varying lighting unit intensities of a flat-surface reflector tray over a particular area is provided, wherein two reference lines have been drawn to identify the 1.0 MH and 1.75 MH markers. In FIG. 4B, a similar plot is provided with respect to the varying lighting unit intensities of a curved-surface reflector tray according to an embodiment of the present invention.

As mentioned above, Type II lighting units are those whose 50% peak intensity contour line reaches the region between 1.0 MH and 1.75 MH. A comparison of FIGS. 4A and 4B shows that the 50% contour line 400 of a lighting unit using a curved-surface reflector tray covers a wider area than the 50% contour line 300 of a flat-surface reflector lighting unit. It should also be noted that contour line dimples, such as the dimples identified by arrows 302 and 304 in FIG. 4A, denote areas in which dark bands may appear. In FIG. 4B, however, contour line 400 extends into the area identified by arrows 402 and 404, which indicates that no dark bands are present.

The present invention addresses the need for an improved LED reflector apparatus that reduces dark bands and increases the scope of a lighting unit's 50% peak intensity contour line so that a higher value of the mount height (MH) count can be obtained for a type II or type III distribution. Moreover, by having the curvature of reflector 222 differ from that of reflector 220 (i.e. the reflective surface of reflector 222 includes both a concavity and a convexity while that of reflector 220 only includes a convexity, having a different radius of curvature, etc.), the areas of illumination can be offset from the center position of the light source. Therefore, even if the light source 210 is facing straight down onto a street, the area of illumination can be offset such that it is not centered directly below the light source.

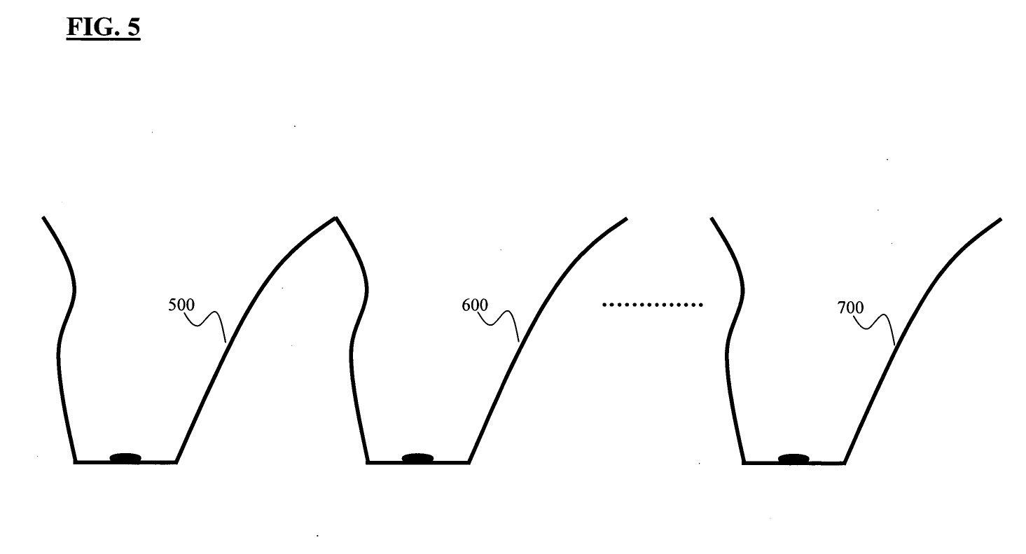

It should be appreciated that, although the present invention has been described above with reference to particular embodiments, those skilled in the art will recognize that changes and modifications may be made in the above described embodiments without departing from the scope of the invention. In FIG. 5, for example, a schematic cross-sectional view of an apparatus having multiple rows of curved-surface multi-LED reflector assemblies 202 and light sources 210 is provided, wherein reflector assemblies 500, 600, and 700 are shown. Furthermore, while the present invention has been described with respect to upper and lower curved reflectors 220 and 222, those skilled in the art will recognize that further enclosing a reflector assembly 202 with right and left curved reflectors having a similar design to reflectors 220, 222 as described above may be desirable. These and other changes and modifications are intended to be included within the scope of the present invention.

What is claimed is:

1. A lighting unit, comprising:
a light source;
a reflector assembly upon which the light source is mounted, wherein the reflector assembly comprises:
a first reflector having a first curved reflective surface, and
a second reflector having a second curved reflective surface, wherein the first curved reflective surface has a curvature that is different from that of the second curved reflective surface.

2. The lighting unit of claim 1, wherein the light source is an LED array.

3. The lighting unit of claim 1, wherein the reflector assembly further comprises:
a back-plate on which the light source is mounted.

4. The lighting unit of claim 3, wherein the back-plate includes a reflective surface.

5. The lighting unit of claim 1, wherein the first reflective surface extends away from the light source and terminates in a convexity.

6. The lighting unit of claim 1, wherein the second reflective surface extends away from the light source and terminates in a convexity.

7. The lighting unit of claim 6, wherein the second reflective surface further comprises a concavity disposed adjacent to the convexity.

8. The lighting unit of claim 3, wherein:
the first reflector extends from the back plate at a first angle of inclination,
the second reflector extends from the back plate at a second angle of inclination that is different from the first angle of inclination.

9. The lighting unit of claim 8, wherein the second angle of inclination is approximately ninety degrees.

10. The lighting unit of claim 1, wherein the reflector assembly further comprises:
a third reflector having a third reflective surface extending between the first and second reflectors;
a fourth reflector having a fourth reflective surface extending between the first and second reflectors.

11. A lighting unit, comprising:
a light source;
a reflector assembly upon which the light source is mounted, wherein the reflector assembly comprises:
a first reflector having a first curved reflective surface extending away from the light source, and
a second reflector having a second curved reflective surface extending away from the light source,
wherein the first curved reflective surface faces and opposes the second curved reflective surface, and wherein the first curved reflective surface has a curvature that is different from that of the second curved reflective surface.

12. The lighting unit of claim 11, wherein the light source is an LED array.

13. The lighting unit of claim 11, wherein the reflector assembly further comprises:
a back plate on which the light source is mounted, wherein the first and second reflectors extend from the back plate.

14. The lighting unit of claim 13, wherein the back-plate includes a reflective surface.

15. The lighting unit of claim 11, wherein the first reflective surface terminates in a convexity.

16. The lighting unit of claim 11, wherein the second reflective surface templates in a convexity.

17. The lighting unit of claim 16, wherein the second reflective surface further comprises a concavity disposed adjacent to the convexity.

18. The lighting unit of claim 13, wherein:
the first reflector extends from the back plate at a first angle of inclination,
the second reflector extends from the back plate at a second angle of inclination that is different from the first angle of inclination.

19. The lighting unit of claim 88, wherein the second angle of inclination is approximately ninety degrees.

20. The lighting unit of claim 1, wherein the reflector assembly further comprises:
a third reflector having a third reflective surface extending between the first and second reflectors;
a fourth reflector having a fourth reflective surface extending between the first and second reflectors.
